(19) United States
(12) Patent Application Publication
(10) Pub. No.: US 2024/0365281 A1
(43) Pub. Date: Oct. 31, 2024

(54) STEP SIZE AND HEADING PREDICTION IN POSITION ESTIMATION

(71) Applicant: Samsung Electronics Co., Ltd., Suwon-si (KR)

(72) Inventors: Rebal Jurdi, Allen, TX (US); Neha Dawar, McKinney, TX (US); Yuming Zhu, Plano, TX (US); Johnny Kyu-Hui Han, Seoul (KR)

(21) Appl. No.: 18/637,268

(22) Filed: Apr. 16, 2024

Related U.S. Application Data
(60) Provisional application No. 63/462,425, filed on Apr. 27, 2023.

(51) Int. Cl. H04W 64/00; H04B 7/06; H04B 17/318

(52) U.S. Cl. CPC H04W 64/006; H04B 7/0626; H04B 17/328

(57) ABSTRACT

A method and device for estimating the position of a moving object associated with a user. The estimation includes receiving an acceleration signal and an orientation signal, receiving ranging measurements, generating step size and heading information based on the acceleration signal and the orientation signal, and determining the position of the object based on the ranging measurements and the step size and heading information.

### CROSS-REFERENCE TO RELATED APPLICATIONS

This application claims the benefit of priority from U.S. Provisional Application No. 63/462,425, entitled “PEDESTRIAN DEAD RECKONING UNIT FOR ENHANCED PREDICTION OF STEP SIZE AND HEADING”, filed Apr. 27, 2023, which is incorporated herein by reference in its entirety.

### TECHNICAL FIELD

This disclosure relates generally to estimating the position of a moving object, and more particularly to, for example, and not limited to, enhancing step size and heading prediction in pedestrian dead reckoning.

### BACKGROUND

Estimating pedestrian position or location is a helpful, and can even be crucial, aspect for various applications, ranging from traffic management to location-based services, such as commercial, personal, public, or emergency services. For example, as pedestrians navigate through outdoors or indoors environments, accurately tracking their movements becomes essential for optimizing and delivering personalized experiences. Pedestrian dead reckoning (PDR) is a method of estimating the position or location of a pedestrian as they move through an environment without relying on external positioning systems, like Global Positioning System (GPS).

The description set forth in the background section should not be assumed to be prior art merely because it is set forth in the background section. The background section may describe aspects or embodiments of the present disclosure.

### SUMMARY

One embodiment of the present disclosure may provide a method for estimating the position of an object. The method may comprise receiving an acceleration signal and an orientation signal; receiving one or more ranging measurements; generating step size information based on the acceleration signal; generating step heading information based on the orientation signal; and estimating the position of the object based on the one or more ranging measurements, the step size information and the heading information.

In some embodiments, the one or more ranging measurements may include distance information between the object and one or more anchor points.

In some embodiments, generating the step size information may comprise detecting a plurality of peaks in the acceleration signal based on a target peak height and a target inter-peak time.

In some embodiments, generating the step size information may comprise predicting the target peak height based on a number of acceleration samples in the acceleration signal.

In some embodiments, generating the step size information may comprise estimating step size based on the detected plurality of peaks.

In some embodiments, the step heading information may be determined based on orientation information in the orientation signal using a moving average method that attributes greater weight to a predetermined number of recent orientation information.

In some embodiments, each detected peak may have a peak that is greater than or equal to the target peak height and a duration between the peak and an immediately preceding peak is greater than or equal to the target inter-peak time.

In some embodiments, predicting the target peak height may comprise setting the target peak height to a default value when the number of acceleration samples is less than a first threshold; and setting the target peak height using a function of a percentile amplitude of a number of recent acceleration samples when the number of acceleration samples is larger than the first threshold and a multiple of a predetermined value.

In some embodiments, the method may further comprise obtaining the acceleration signal and the orientation signal; and filtering the acceleration signal and the orientation using a low-pass filter.

In some embodiments, the distance may be determined using one of time of flight, round-trip time, downlink time difference of arrival, uplink time difference of arrival, received signal strength indicator, or channel state information.

One embodiment of the present disclosure may provide a device for estimating a position of an object associated with a user. The device may comprise a memory; and a circuitry connected to the memory, the circuitry may be configured to: receive an acceleration signal and an orientation signal; receive one or more ranging measurements; generate step size information based on the acceleration; generate step heading information based on the orientation signal; and estimate the position of the object based on the one or more ranging measurements, the step size information and the heading information.

In some embodiments, the one or more ranging measurements may include distance information between the object and one or more anchor points.

In some embodiments, to generate the step size information, the circuitry may be configured to detect a plurality of peaks in the acceleration signal based on a target peak height and a target inter-peak time.

In some embodiments, to generate the step size information, the circuitry may be configured to predict the target peak height based on a number of acceleration samples in the acceleration signal.

In some embodiments, to generate the step size information, the circuitry may be configured to estimate step size based on the detected plurality of peaks.

In some embodiments, the step heading information may be determined based on orientation information in the orientation signal using a moving average method that attributes greater weight to a predetermined number of orientation information.

In some embodiments, each detected peak may have a peak that is greater than or equal to the target peak height and a duration between the peak and an immediately preceding peak is greater than or equal to the target inter-peak time.

In some embodiments, to predict the target peak height, the circuitry may be configured to: set the target peak height to a default value when the number of acceleration samples is less than a first threshold; and set the target peak height using a function of a percentile amplitude of a number of recent acceleration samples when the number of acceleration samples is larger than the first threshold and a multiple of a predetermined value.

In some embodiments, the circuitry may further be configured to: obtain the acceleration signal and the orientation signal; and filter the acceleration signal and the orientation using a low-pass filter.

In some embodiments, the distance is determined using one of time of flight, round-trip time, downlink time difference of arrival, uplink time difference of arrival, received signal strength indicator, or channel state information.

### BRIEF DESCRIPTION OF THE DRAWINGS

FIG. 1 shows an example of a wireless network in which the present disclosure may operate, according to some embodiments.

FIG. 2 shows an example of an anchor point, according to some embodiments.

FIG. 3 shows an example of a mobile device, according to some embodiments.

FIG. 4 shows an example of a timing diagram depicting signaling to compute time of flight (ToF), according to some embodiments.

FIG. 5 shows an example of a timing diagram depicting signaling to compute round-trip time (RTT), according to some embodiments.

FIG. 6A shows an example of a timing diagram depicting signaling to compute Downlink time difference of arrival (Downlink TDoA), according to some embodiments.

FIG. 6B shows an example visual illustration of a downlink TDoA system, according to some embodiments.

FIG. 7 shows an example of a timing diagram depicting signaling to compute Uplink time difference of arrival (Uplink TDoA), according to some embodiments.

FIG. 8 shows an example visual illustration of trilateration, according to some embodiments.

FIG. 9 shows an example high-level block diagrams of processes for position estimation, according to some embodiments.

FIG. 10 shows an example of a high-level block diagram depicting a positioning module, according to some embodiments.

FIG. 11 shows an example of a high-level flow diagram depicting a process for position estimation, according to some embodiments.

FIG. 12A shows an example high-level diagram of a pedestrian dead reckoning unit (PDRU), according to some embodiments.

FIG. 12B shows an example of a high-level flow diagram depicting a process for step size and heading estimation, according to some embodiments.

FIG. 13 shows an example of a flow diagram depicting a process for processing filtered acceleration on a sample-by-sample basis, according to some embodiments.

FIGS. 14A and 14B show an example of a flow diagram depicting a process for predicting the target peak height, according to some embodiments.

FIG. 15 shows a graph depicting an example of the process of predicting a peak height, according to some embodiments.

FIG. 16A shows a graph depicting an example of the process of estimating a step size, according to some embodiments.

FIG. 16B shows an example of a high-level flow diagram depicting a process for computing step size, according to some embodiments.

FIG. 17 shows an example of a high-level flow diagram depicting a process for estimating the step heading, according to some embodiments.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The present disclosure relates to communication systems, including, but not limited to, wireless communication systems, for example, to a Wireless Local Area Network (WLAN) technology. WLAN allows devices to access the internet in the 2.4 GHz, 5 GHz, 6 GHz or 60 GHz frequency bands. WLANs are based on the Institute of Electrical and Electronic Engineers (IEEE) 802.11 standards. IEEE 802.11 family of standards aim to increase speed and reliability and to extend the operating range of wireless networks.

The following description is directed to certain implementations for the purpose of describing the innovative aspects of this disclosure. However, a person having ordinary skill in the art will readily recognize that the teachings herein may be applied in a multitude of different ways. The described embodiments may be implemented in any device, system or network that is capable of transmitting and receiving signals, for example, radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router”, “gateway”, or “anchor point”. For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

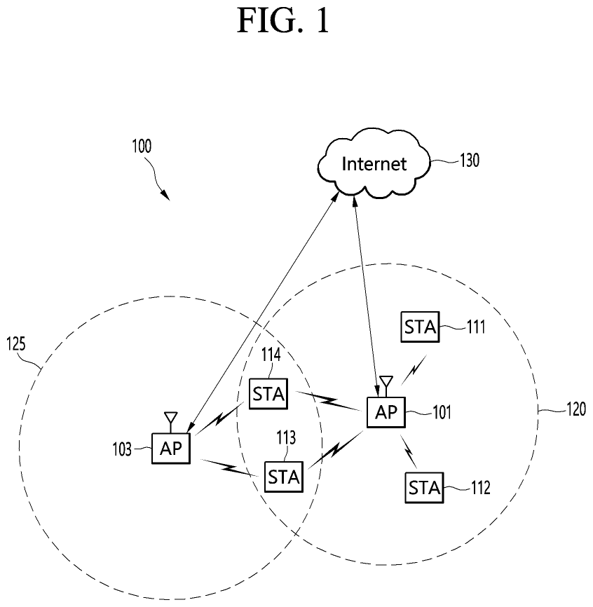

FIG. 1 shows an example of a wireless network 100, in accordance with some embodiments, in which the present disclosure may operate. The embodiment of the wireless network 100 shown in FIG. 1 is for illustrative purposes only. Other embodiments of the wireless network 100 may be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 may communicate with at least one network 130, such as the Internet, a proprietary Internet Protocol (IP) network, or other data network. The AP 101 provides wireless access to the network 130 for a plurality of stations (STAs) 111-114 with a coverage area 120 of the AP 101. The APs 101 and 103 may communicate with each other and with the STAs using Wi-Fi or other WLAN communication techniques.

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 may include any number of APs and any number of STAs in any suitable arrangement. Also, the AP 101 may communicate directly with any number of STAs and provide those STAs with wireless broadband access to the network 130. Similarly, each AP 101 and 103 may communicate directly with the network 130 and provides STAs with direct wireless broadband access to the network 130. Further, the APs 101 and/or 103 may provide access to other or additional external networks, such as external telephone networks or other types of data networks.

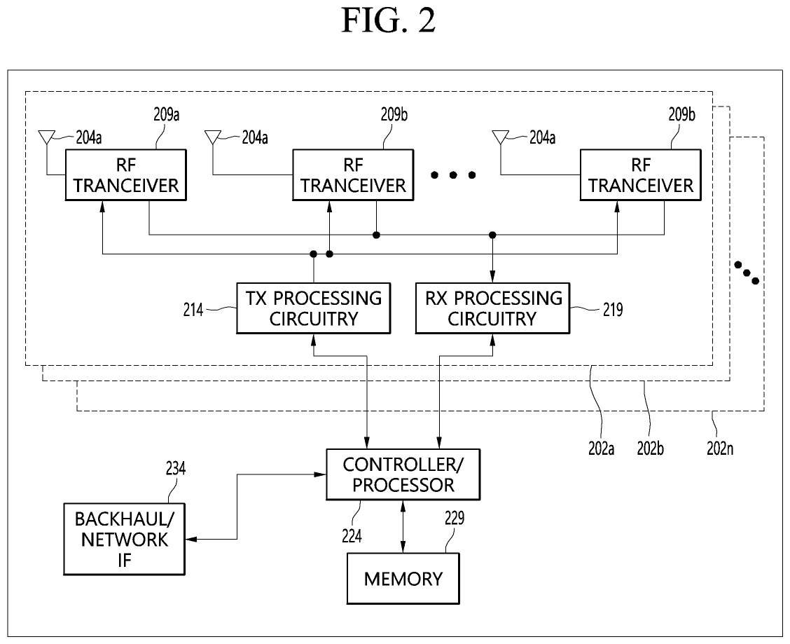

FIG. 2 shows an example of an AP 101 in accordance with some embodiments. The embodiment of the AP 101 shown in FIG. 2 is for illustrative purposes, and the AP 103 of FIG. 1 may have the same or similar configuration. However, APs come in a wide range of configurations, and FIG. 2 does not limit the scope of this disclosure to any particular implementation of an AP.

As shown in FIG. 2, the AP 101 may include multiple antennas 204a-204n, multiple radio frequency (RF) transceivers 209a-209n, transmit (TX) processing circuitry 214, and receive (RX) processing circuitry 219. The AP 101 may also include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 may include one or more processors or other processing devices that control the overall operation of the AP 101. For example, the controller/processor 224 may control the reception of uplink signals and the transmission of downlink signals by the RF transceivers 209a-209n, the RX processing circuitry 219, and the TX processing circuitry 214 in accordance with well-known principles. The controller/processor 224 may support additional functions as well, such as more advanced wireless communication functions. For instance, the controller/processor 224 may support beam forming or directional routing operations in which outgoing signals from multiple antennas 204a-204n are weighted differently to effectively steer the outgoing signals in a desired direction. The controller/processor 224 may also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 may also be capable of executing programs and other processes resident in the memory 229, such as an OS. The controller/processor 224 may move data into or out of the memory 229 as required by an executing process.

The controller/processor 224 may also be coupled to the backhaul or network interface 234. The backhaul or network interface 234 may allow the AP 101 to communicate with other devices or systems over a backhaul connection or over a network. The interface 234 may support communications over any suitable wired or wireless connection(s). For example, the interface 234 may allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 may be coupled to the controller/processor 224. Part of the memory 229 may include a RAM, and another part of the memory 229 may include a Flash memory or other ROM.

As described in more detail below, the AP 101 may include circuitry and/or programming for management of channel sounding procedures in WLANs. Although FIG. 2 illustrates one example of AP 101, various changes may be made to FIG. 2. For example, the AP 101 may include any number of each component shown in FIG. 2. As a particular example, an AP may include a number of interfaces 234, and the controller/processor 224 may support routing functions to route data between different network addresses. As another example, while shown as including a single instance of TX processing circuitry 214 and a single instance of RX processing circuitry 219, the AP 101 may include multiple instances of each (such as one per RF transceiver). Alternatively, only one antenna and RF transceiver path may be included, such as in legacy APs. Also, various components in FIG. 2 may be combined, further subdivided, or omitted and additional components may be added according to particular needs.

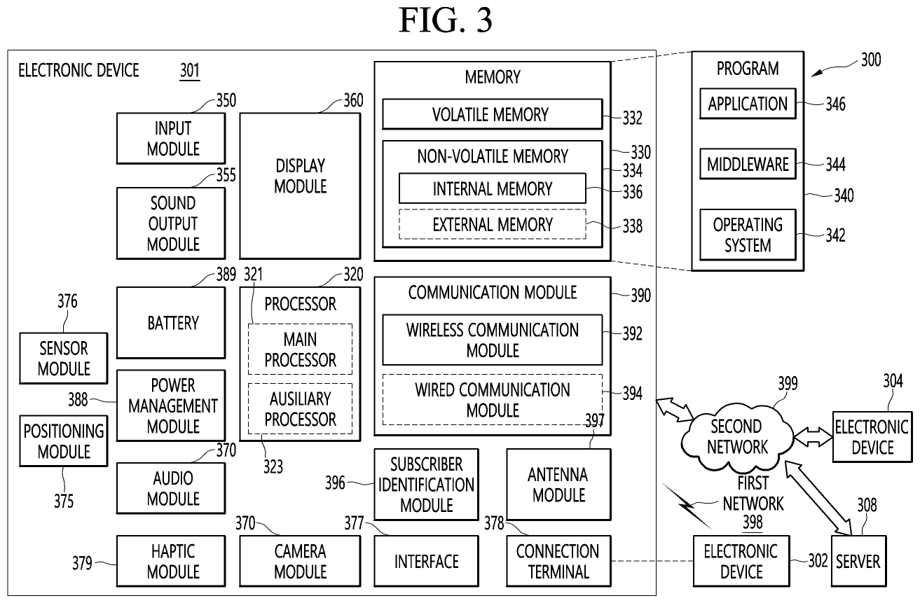

FIG. 3 shows an example of a STA 111 in accordance with some embodiments. The embodiment of the STA 111 shown in FIG. 3 is for illustrative purposes, and the STAs 111-114 of FIG. 1 may have the same or similar configuration. However, STAs come in a wide variety of configurations, and FIG. 3 does not limit the scope of this disclosure to any particular implementation of a STA.

In the example of FIG. 3, the STA may be an electronic device 301, for example, a mobile device (such as a mobile telephone, a smartphone, etc.) or a stationary device (such as a desktop computer, AP, or a media player, etc.).

As shown in FIG. 3, the electronic device 301 in the network environment 300 may communicate with an electronic device 302 via a first network 398 (e.g., a short-range wireless communication network), or an electronic device 304 or a server 308 via a second network 399 (e.g., a long-range wireless communication network). The first network 398 or the second network 399 may be, for example, a wireless local area network (WLAN) conforming IEEE 802.11be standard or any future amendments to IEEE 802.11 standard.

According to some embodiments, the electronic device 301 may communicate with the electronic device 304 via the server 308. According to some embodiments, the electronic device 301 may include a processor 320, memory 330, an input module 350, a sound output module 355, a display module 360, an audio module 370, a sensor module 376, an interface 377, a connecting terminal 378, a haptic module 379, a camera module 380, a power management module 388, a battery 389, a communication module 390, a subscriber identification module (SIM) 396, or an antenna module 397. In some embodiments, at least one of the components (e.g., the connecting terminal 378) may be omitted from the electronic device 301, or one or more other components may be added in the electronic device 301. In some embodiments, some of the components (e.g., the sensor module 376, the camera module 30, or the antenna module 397) may be implemented as a single component (e.g., the display module 360).

The processor 320 may execute, for example, software (e.g., a program 340) to control at least one other component (e.g., a hardware or software component) of the electronic device 301 coupled with the processor 320 and may perform various data processing or computation. According to some embodiments, as at least part of the data processing or computation, the processor 320 may store a command or data received from another component (e.g., the sensor module 376 or the communication module 390) in volatile memory 332, process the command or the data stored in the volatile memory 332, and store resulting data in non-volatile memory 334. According to some embodiments, the processor 320 may include a main processor 321 (e.g., a central processing unit (CPU) or an application processor), or an auxiliary processor 323 (e.g., a graphics processing unit (GPU), a neural processing unit (NPU), an image signal processor (ISP), a sensor hub processor, or a communication processor (CP)) that is operable independently from, or in conjunction with, the main processor 321. For example, when the electronic device 301 includes the main processor 321 and the auxiliary processor 323, the auxiliary processor 323 may be adapted to consume less power than the main processor 321, or to be specific to a specified function. The auxiliary processor 323 may be implemented as separate from, or as part of the main processor 321.

The auxiliary processor 323 may control at least some of functions or states related to at least one component (e.g., the display module 360, the sensor module 376, or the communication module 390) among the components of the electronic device 301, instead of the main processor 321 while the main processor 321 is in an inactive (e.g., sleep) state, or together with the main processor 321 while the main processor 321 is in an active state (e.g., executing an application). According to some embodiments, the auxiliary processor 323 (e.g., an ISP or a CP) may be implemented as part of another component (e.g., the camera module 380 or the communication module 390) functionally related to the auxiliary processor 323. According to some embodiments, the auxiliary processor 323 (e.g., the NPU) may include a hardware structure specified for artificial intelligence model processing. An artificial intelligence model may be generated by machine learning. Such learning may be performed, e.g., by the electronic device 301 where the artificial intelligence is performed or via a separate server (e.g., the server 308). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 330 may store various data used by at least one component (e.g., the processor 320 or the sensor module 376) of the electronic device 301. The various data may include, for example, software (e.g., the program 340) and input data or output data for a command related thereto. The memory 330 may include the volatile memory 332 or the non-volatile memory 334.

The program 340 may be stored in the memory 330 as software, and may include, for example, an operating system (OS) 342, middleware 344, or one or more applications 346.

The input module 350 may receive a command or data to be used by another component (e.g., the processor 320) of the electronic device 301, from the outside (e.g., a user) of the electronic device 301. The input module 350 may include, for example, a microphone, a mouse, a keyboard, a key (e.g., a button), or a digital pen (e.g., a stylus pen).

The sound output module 355 may output sound signals to the outside of the electronic device 301. The sound output module 355 may include, for example, a speaker or a receiver. The speaker may be used for general purposes, such as playing multimedia or playing recorded data. The receiver may be used for receiving incoming calls. According to some embodiments, the receiver may be implemented as separate from, or as part of the speaker.

The display module 360 may visually provide information to the outside (e.g., a user) of the electronic device 301. The display module 360 may include, for example, a display, a hologram device, or a projector and control circuitry to control a corresponding one of the display, hologram device, and projector. According to some embodiments, the display module 360 may include a touch sensor adapted to detect a touch, or a pressure sensor adapted to measure the intensity of force incurred by the touch.

The audio module 370 may convert a sound into an electrical signal and vice versa. According to some embodiments, the audio module 370 may obtain the sound via the input module 350 or output the sound via the sound output module 355 or a headphone of an external electronic device (e.g., an electronic device 302) directly (e.g., wiredly) or wirelessly coupled with the electronic device 301.

The sensor module 376 may detect an operational state (e.g., power or temperature) of the electronic device 301 or an environmental state (e.g., a state of a user) external to the electronic device 301, and then generate an electrical signal or data value corresponding to the detected state. According to some embodiments, the sensor module 376 may include, for example, and not limited to, a gesture sensor, a gyro sensor or gyroscope, an atmospheric pressure sensor, a magnetic sensor or magnetometer, an acceleration sensor or accelerometer, a grip sensor, a proximity sensor, a color sensor, an infrared (IR) sensor, a biometric sensor, a temperature sensor, a humidity sensor, or an illuminance sensor. The example shows the sensor module 376 as one module for convenience, however, the sensor module 376 may include one or more sensors.

The interface 377 may support one or more specified protocols to be used for the electronic device 301 to be coupled with the external electronic device (e.g., the electronic device 302) directly (e.g., wiredly) or wirelessly. According to some embodiments, the interface 377 may include, for example, a high-definition multimedia interface (HDMI), a universal serial bus (USB) interface, a secure digital (SD) card interface, or an audio interface.

A connecting terminal 378 may include a connector via which the electronic device 301 may be physically connected with the external electronic device (e.g., the electronic device 302). According to some embodiments, the connecting terminal 378 may include, for example, an HDMI connector, a USB connector, an SD card connector, or an audio connector (e.g., a headphone connector).

The positioning module 375 may detect the position or location of the device 301, including when the device 301 is moving, e.g., when the device 301 is a portable device held by or attached to a user. As will be described in further details herein, the positioning module 375 may be a part of one or more components, or the positioning module 375 may be include one or more components.

The haptic module 379 may convert an electrical signal into a mechanical stimulus (e.g., a vibration or a movement) or electrical stimulus which may be recognized by a user via his tactile sensation or kinesthetic sensation. According to an embodiment, the haptic module 379 may include, for example, a motor, a piezoelectric element, or an electric stimulator.

The camera module 380 may capture a still image or moving images. According to some embodiments, the camera module 380 may include one or more lenses, image sensors, ISPs, or flashes.

The power management module 388 may manage power supplied to the electronic device 301. According to some embodiments, the power management module 388 may be implemented as at least part of, for example, a power management integrated circuit (PMIC).

The battery 389 may supply power to at least one component of the electronic device 301. According to some embodiments, the battery 389 may include, for example, a primary cell which is not rechargeable, a secondary cell which is rechargeable, or a fuel cell.

The communication module 390 may support establishing a direct (e.g., wired) communication channel or a wireless communication channel between the electronic device 301 and the external electronic device (e.g., the electronic device 302, the electronic device 304, or the server 308) and performing communication via the established communication channel. The communication module 390 may include one or more CPs that are operable independently from the processor 320 (e.g., the application processor) and supports a direct (e.g., wired) communication or a wireless communication. According to some embodiments, the communication module 390 may include a wireless communication module 392 (e.g., a cellular communication module, a short-range wireless communication module, or a global navigation satellite system (GNSS) communication module) or a wired communication module 394 (e.g., a local area network (LAN) communication module or a power line communication (PLC) module). A corresponding one of these communication modules may communicate with the external electronic device via the first network 398 (e.g., a short-range communication network, such as Bluetooth™, Wi-Fi direct, or IR data association (IrDA)) or the second network 399 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 392 may identify and authenticate the electronic device 301 in a communication network, such as the first network 398 or the second network 399, using subscriber information (e.g., international mobile subscriber identity (IMSI)) stored in the SIM 396.

The wireless communication module 392 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 392 may support a high-frequency band (e.g., the mmWave band) to achieve, e.g., a high data transmission rate. The wireless communication module 392 may support various technologies for securing performance on a high-frequency band, such as, e.g., beamforming, massive multiple-input and multiple-output (MIMO), full dimensional MIMO (FD-MIMO), array antenna, analog beam-forming, or large-scale antenna. The wireless communication module 392 may support various requirements specified in the electronic device 301, an external electronic device (e.g., the electronic device 304), or a network system (e.g., the second network 399). According to some embodiments, the wireless communication module 392 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 397 may transmit or receive a signal or power to or from the outside (e.g., the external electronic device) of the electronic device 301. According to an embodiment, the antenna module 397 may include an antenna including a radiating element composed of a conductive material or a conductive pattern formed in or on a substrate (e.g., a printed circuit board (PCB)). According to an embodiment, the antenna module 397 may include a plurality of antennas (e.g., array antennas). In such a case, at least one antenna appropriate for a communication scheme used in the communication network, such as the first network 398 or the second network 399, may be selected, for example, by the communication module 390 (e.g., the wireless communication module 392) from the plurality of antennas. The signal or the power may then be transmitted or received between the communication module 390 and the external electronic device via the selected at least one antenna. According to an embodiment, another component (e.g., a radio frequency integrated circuit (RFIC)) other than the radiating element may be additionally formed as part of the antenna module 397.

According to various embodiments, the antenna module 397 may form a mmWave antenna module. According to some embodiments, the mmWave antenna module may include a PCB, a RFIC disposed on a first surface (e.g., the bottom surface) of the PCB, or adjacent to the first surface and capable of supporting a designated high-frequency band (e.g., the mmWave band), and a plurality of antennas (e.g., array antennas) disposed on a second surface (e.g., the top or a side surface) of the PCB, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to some embodiments, commands or data may be transmitted or received between the electronic device 301 and the external electronic device 304 via the server 308 coupled with the second network 399. Each of the electronic devices 302 or 304 may be a device of a same type as, or a different type, from the electronic device 301. According to some embodiments, all or some of operations to be executed at the electronic device 301 may be executed at one or more of the external electronic devices 302, 304, or 308. For example, if the electronic device 301 should perform a function or a service automatically, or in response to a request from a user or another device, the electronic device 301, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 301. The electronic device 301 may provide the outcome, with or without further processing of the outcome, as at least part of a reply to the request. To that end, a cloud computing, distributed computing, mobile edge computing (MEC), or client-server computing technology may be used, for example. The electronic device 301 may provide ultra-low-latency services using, e.g., distributed computing or MEC. In another embodiment, the external electronic device 304 may include an Internet-of-things (IoT) device. The server 308 may be an intelligent server using machine learning and/or a neural network. According to some embodiments, the external electronic device 304 or the server 308 may be included in the second network 399. The electronic device 301 may be applied to intelligent services (e.g., smart home, smart city, smart car, or healthcare) based on 5G communication technology or IoT-related technology.

As mentioned herein, a network stream may contain multiple types of services. A service (or network service) may be a function provided over a network infrastructure that facilitates application-level interactions and data exchanges, in a network data stream (or network stream), between connected devices. A network stream may include voice, video and data traffic. Generally, at a high-level description, the present disclosure provides a network detection service that may accurately identify different types of services in a network stream. In some embodiments, the network detection service may be implemented in a user device, such as user device 300.

Technologies described in present disclosure may include, in some embodiments, device-based positioning. Device-based positioning refers to finding the position of a user through a device that the user is holding or wearing, or that is attached to the user. Technologies for device-based positioning may fall into one of three broad categories: wireless, or range-based technology; pedestrian dead reckoning (PDR), or sensor-based technology; and sensor fusion, or range-plus-sensor-based technology.

In wireless, or range-based technology, a position may be estimated from range measurements, e.g., measurements of distance with anchor points, or reference points, with known position coordinates. Examples of range measurements (including differential ranges), also known as ranges, may include received signal strength indicator (RSSI), time of flight (ToF), round-trip time (RTT), time difference of arrival (TDoA), which are mostly available in common wireless technologies such as WiFi, Bluetooth, and ultra-wide band (UWB).

In pedestrian dead reckoning, or sensor-based technology, a position may be estimated by accumulating increment displacements on top of a known initial position. In some implementations, the displacement may be computed from one or more sensor readings, e.g., magnetometer, accelerometer, and gyroscope.

In range-plus-sensor-based technology, a position may first be estimated from sensor readings through PDR and then updated through fusion with range measurements.

Technologies described in present disclosure may also include, in some embodiments, wireless (or range-based) positioning. In this ranged-based positioning, a device may establish its position by measuring its distance with a set of reference points with known locations, also known as anchor points. Measuring the distance to another device, e.g., an anchor point, may involve wireless signaling between the two devices known as ranging, and is supported by most wireless technologies either explicitly through standard ranging mechanisms or implicitly through receive power or channel impulse response measurement capabilities. Below are examples of commonly used ranging mechanisms (for simplicity, it is assumed that clocks are synchronized across all devices, and imperfections such as clock drift are absent).

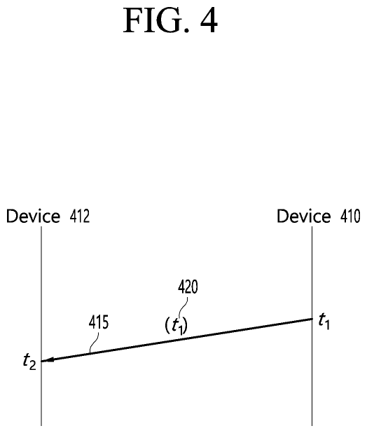

Time of flight (ToF): As shown in FIG. 4, one device 410, typically an anchor point, sends a message 415 to the target device 412, embedding a timestamp 420 at t₁ which the message was sent. The target device 412 picks up the message, decodes it, timestamps its reception at t₂, and computes the time of flight and corresponding device-AP distance as: r=c (t₁−t₂), where c is the speed of light.

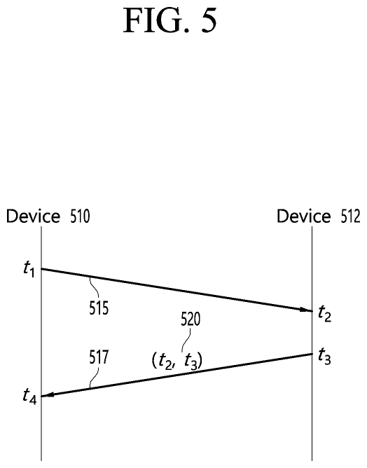

Round-trip time (RTT): As shown in FIG. 5, one device 510, typically the target device, sends an empty message 515 to the anchor point 512 and timestamps the transmission time at t₁. The anchor point 512 picks up the message 515, timestamps the reception time t₂, responds with a message 517, timestamps that at time t₃, and embeds the two timestamps 520 in the response message 517. The target device 510 then picks up the response 517, timestamps the reception at time t₄, extracts the two embedded timestamps 520, and computes the round-trip time from the 2 pairs of timestamps, one at the device side, and another at the anchor point side, as well as the device-AP distance as: r=c (t₄−t₁−t₃+t₂)/2.

In some embodiments, the target device 510 may estimate its (two-dimensional) position from 3 or more ranges using the methods explained above, with the only difference being the fact that RTT would be used to compute the device-AP distance instead of ToF. This mechanism is in UWB, known as two-way ranging (TWR), and in WiFi under IEEE 802.11 standard, known as fine timing measurement (FTM).

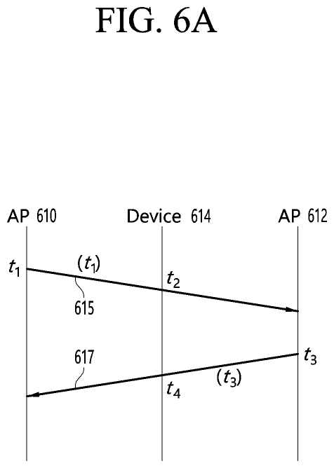

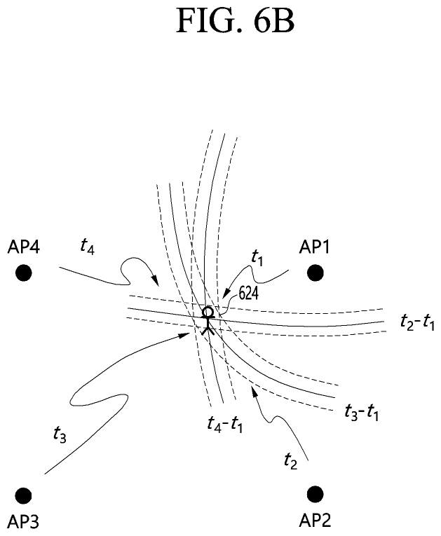

Downlink time difference of arrival (Downlink TDoA): As shown in FIG. 6A, a target device 614 does not determine its position by actively ranging with an anchor point, but rather by listening to the ranging between different pairs of anchor points 610 and 612 to estimate the difference in the device-AP distances. An example of computing the distance difference is as follows. The 2 anchor points 610 and 612 range with one another using the two-way ranging method explained above. The target device 614 timestamps the time t₂ at which it overhears the message 615 sent by the anchor point 610 initiating the exchange and extracts the timestamp t₁ at which the message was sent. The target device 614 also timestamps the time t₄ at which it overhears the message 617 sent by the anchor point 612 responding to the initiating anchor point 610 and extracts the timestamp t₃ at which the response 617 was sent. The target device 614 then estimates the difference in the distances from the two anchor points as: Δr=c (t₄−t₂)−c(t₃−t₁).

FIG. 6B shows an example visual illustration of a downlink TDoA system where a device 624 (shown held by a user) needing to determine its position passively listens to the message exchange between pairs of anchor points at known positions and estimates the difference in distance with the anchor points of the pair.

In some embodiments, to estimate its two-dimensional position, the target device may measure the distance difference for at least 3 pairs of anchors, for a minimum total of 4 anchors. It computes its position as the intersection of 3 or more hyperbolas. This method may be readily used in UWB where a ranging device can be configured to listen to ranging participants without actively participating in ranging.

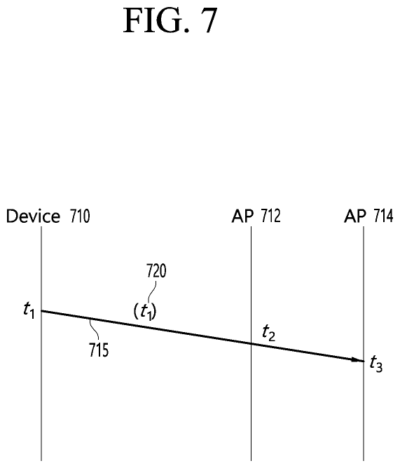

Uplink time difference of arrival (Uplink TDoA): As shown in FIG. 7, a target device 710 may send a message 715 embedding the expected time of transmission 720. The message 715 is received by a set of collaborating anchor points 712 and 714 at different times. Similar to downlink TDoA, a set of time differences is computed from which a set of corresponding distance differences and ultimately a position may be estimated. Through this mechanism, the location of a mobile device 710 may be estimated by the cellular network. Applied to indoor positioning, however, any technology through which inter-device distances can be estimated allows for uplink TDoA to be used for position estimation.

Received signal strength indicator (RSSI): In this mechanism, the receive power at a target device is equal to the transmit power at an anchor point less propagation losses that are a function of the device-anchor distance. Using a standard propagation model, e.g. the ITU indoor propagation model for WiFi, or a propagation model fitted on empirical data, the RSSI can be converted in a distance. One example model is the one-slope linear model expressing the relationship between RSSI and distance as follows: RSSI=β+α(log d), where α and β are fitting parameters. Following the inversion of RSSIs into distances, standard positioning methods that turn a set of distance measurements to a single position can be applied, e.g., trilateration.

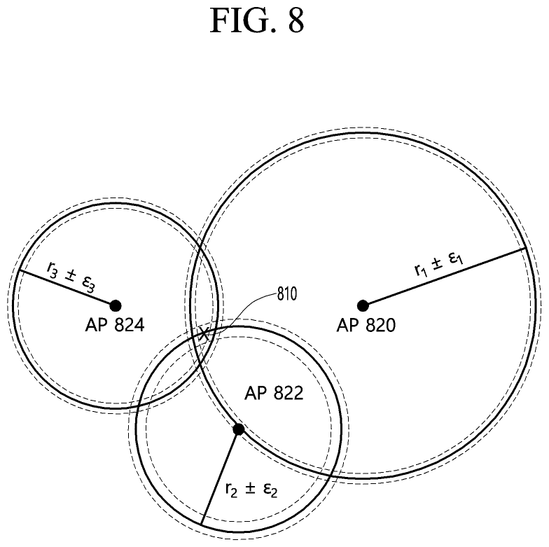

In FIG. 8, an example visual illustration of trilateration is shown. This method estimates the position of a device 810 (“X”) from a set of range measurements, each with an anchor point at a known location; range measurements may be inferred from a variety of measured physical quantities, e.g., time of flight (ToF), round-trip time (RTT), or receive power (RSSI). For example, to estimate its two-dimensional position, a target device 810 may measure its distance from at least 3 anchor points 820, 822, 824. The target device 810 computes its position as the intersection of 3 or more circles centered around the 3 anchor points, the radius of each is the corresponding device-AP distance. This method in range-based positioning is known as trilateration, or multi-lateration when there are more than 3 anchor points. Other, more sophisticated methods of position estimation from range measurements include Bayesian filtering, e.g., the Kalman filter. The ranging mechanism to compute time of flight computation may use the UWB technology.

Channel state information (CSI): In this mechanism, the target device may estimate the channel frequency response, or alternatively the channel impulse response, which expresses how the environment affects different frequency components in terms of both their magnitude as well as their phase. Monitoring the changes in phase over time and over a range of frequencies can be used to compute the device-AP distance. Other methods may also be used, e.g., multi-carrier phase difference used with Bluetooth low energy.

As mentioned above, besides or in addition to wireless (or range-based) positioning technologies, pedestrian dead reckoning (PDR) may also be used in position estimation. Dead reckoning is a method of estimating the position of a moving object using the object's last known position and adding incremental displacements to that. Pedestrian dead reckoning, or PDR, refers specifically to the scenario where the object is a pedestrian walking in an indoor or outdoor space. With the proliferation of sensors inside smart devices, e.g., smartphones, tablets, and smartwatches, PDR has naturally evolved to supplement wireless positioning technologies that have been long supported by these devices such as WiFi and cellular service, as well as more recent and less common technologies such as ultra-wide band (UWB).

In some embodiments, a smart device may include an inertial measurement unit (IMU). An IMU may be a module that combines numerous sensors with functional differences, e.g., an accelerometer for measuring linear acceleration, a gyroscope for measuring angular velocity, a magnetometer for measuring the strength and direction of the magnetic field, and so on. These sensors can estimate the trajectory of the device. In some embodiments, combining IMU sensor data and ranging measurements, e.g., from wireless chipsets like WiFi and UWB, or sensor fusion, may improve positioning accuracy, e.g., by reducing uncertainty.

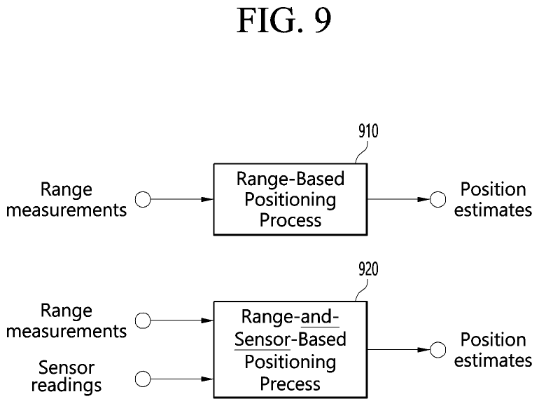

FIG. 9 shows an example high-level block diagrams of processes for position estimation. For example, process 910 uses only range-based positioning technology, which estimates position from range measurements. Process 920 uses range-and-sensor-based technology, i.e., technology that is based on sensor fusion, which estimates position from both range measurements and sensor readings.

In some embodiments, PDR methods may generally include two categories: inertial navigation (IN) methods, and step & heading (SH) methods.

IN methods may track the position of the device and its orientation, i.e., the direction it is facing in two- or three-dimensional (3D) space (also known as attitude or bearing). To determine the instantaneous position of the device, IN methods may integrate the 3D acceleration to obtain velocity, and then integrate the velocity to determine the displacement from the start point. To obtain the instantaneous orientation of the device, IN methods may integrate the angular velocity, e.g., from a gyroscope, to obtain the change in angles from the initial orientation. Measurement noise and biases at the levels of accelerometer and gyroscope may lead to a linear growth of orientation offset across time due to the integration of rotational velocity, and to quadratic growth of displacement error across time due to double integration of the acceleration. This may put the IN method in a tradeoff between positioning accuracy and computational complexity, as tracking and overcoming the biases in the sensor readings as well as the statistics of the measurement noise across time often may require a complex filter with a high-dimensional state vector.

Unlike IN methods that track the position of the device continuously, SH methods may update the device position less frequently by accumulating the steps that a user takes from a start point. Every step may be described as a vector whose magnitude is the size of the step and whose argument is the heading of the step. Instead of directly integrating sensor readings to compute displacement and change in orientation, SH methods may perform a sequence of operations towards that end. For example, first, an SH system may detect a step or stride using one of many different methods, e.g., peak detection, zero-crossing detection, or template matching. Second, once a step or stride is detected, the SH system may estimate the size, or length, of the step from the sequence of acceleration falling within the duration of the step. Third, the SH system may estimate the heading of the step using, e.g., a gyroscope, magnetometer, or a combination of both. All of these three steps are prone to error. For example, step detection may be prone to misdetection, e.g., due to low peaks, false alarm, e.g., due to double peaks, and other drawbacks. Similarly, step size and heading estimation may be prone to errors due to errors in the underlying sensors measurements and idealized models.

Like IN methods, SH methods also involve trading off between computation complexity and positioning accuracy. Both methods may achieve acceptable positioning accuracy at the expense of high computational complexity, which translates into jittery code execution and increased power consumption due to the use of either linear filters whose equations are high dimensional, particle filters with tens, even hundreds of particles, or filter banks with numerous filters.

However, unlike IN systems, in some embodiments, SH systems may be less vulnerable to drifting, especially when the estimated trajectories are corrected with range measurements in a sensor-fusion-based indoor positioning system as described herein.

For example, when PDR is used to supplement a range-based positioning technology, e.g., WiFi RSSI fingerprinting, WiFi Fine Timing Measurement (FTM), or UWB, the PDR system predicting position may not demand the accuracy that it would have if it were to stand alone. In some embodiments, while some PDR solutions use a combination of non-linear filters, filter banks, so-called particle filters, and high dimensional models, a simple and succinct pedestrian dead reckoning unit (PDRU) as disclosed herein may predict the user's trajectory from sensors on board the device that the user is holding as a step prior to correcting said trajectory with range measurements. The present disclosure may be computationally-inexpensive and may achieve a speedup proportional to the number of filters, particles, or dimensions that would have otherwise needed to be used.

As used herein, the pedestrian dead reckoning unit (PDRU) may be or may include a positioning application, which may be implemented in hardware, firmware, or mixed implementations. The present disclosure may include an app which refers to the software manifestation or implementation of an application.

As used herein, the term “module” includes a unit configured in hardware, software, or firmware and may interchangeably be used with other terms, e.g., “logic”, “logic block”, “part”, “unit” or “circuit.” A module may be a single integral part or a minimum unit or part for performing one or more functions. For example, the module may be configured in an application-specific integrated circuit (ASIC).

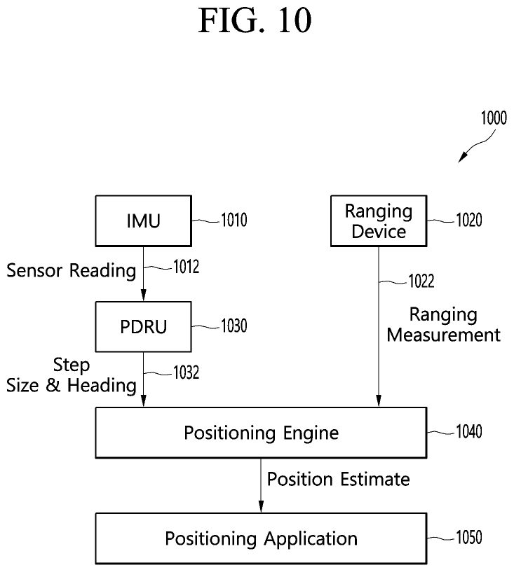

FIG. 10 shows an example of a high-level block diagram depicting a positioning module 1000 for an electronic device. The positioning module 1000 may be a positioning module 375 in the example electronic device 301 in FIG. 3. In some embodiments, the positioning module 1000 may include, for example, an Inertial Measurement Unit (IMU) 1010, a ranging device 1020, a pedestrian dead reckoning unit (PDRU) 1030, a positioning engine 1040, and a positioning application 1050. As shown in the exemplary positioning module 1000, the PDRU 1030 may be one of many interacting components that serve a positioning application 1050.

In some embodiments, the IMU 1010 may contain a variety of sensors that measure the linear and rotational forces acting on the electronic device as well as its orientation. The sensors may convert their measurements into useful physical quantities, e.g., an accelerometer may compute acceleration, a gyroscope may compute rotational velocity, and a magnetometer may compute orientation. The converted measurements (shown as sensor readings 1012) may be inputted to the PDRU 1030.

In some embodiments, the ranging device 1020 may measure the distance between the electronic device and an anchor point or a set of anchor points. In a wireless environment, the ranging device may be, or may be part of, for example:
A WiFi station (STA), where the ranging device may measure RSSI from a WiFi access points and convert that into a distance.
A WiFi STA acting as a Fine Timing Measurement (FTM) Initiator (FTMI), where the ranging device may range with a WiFi access point acting as an FTM responder (FTMR) to compute the round-trip time (RTT) between the two devices, and convert that into a distance.
An Ultra-Wide Band (UWB) ranging device (RDEV) acting as initiator, where the ranging device may range with a UWB tag acting as a responder to compute RTT and convert that into a distance.
A non-participant UWB RDEV, where the ranging device may eavesdrop onto the ranging between UWB tags to compute the time difference of arrival (TDoA) of the signals transmitted by the different ranging participants, and convert that into a distance difference.
A Bluetooth device, where the ranging device may detect its proximity to a deployed Bluetooth beacon, e.g., a Bluetooth transmitter.

In some embodiments, the ranging device may be or may include a laser sensor, for example, a Light Detection and Ranging (LIDAR) sensor.

Output from the ranging device 1020 (shown as ranging measurement 1022) may be inputted to the positioning engine 1040.

In some embodiments, the PDRU 1030 may receive sensor readings 1012 from the IMU 1010 and detect steps and compute their size (length) and heading (direction). Output from the PDRU 1030 (shown as step size & heading 1032) may be inputted to the positioning engine 1040. The PDRU 1030 will be described in further details below.

In some embodiments, the positioning engine 1040 may estimate device position through sensor fusion, e.g., by receiving and using a combination of ranging measurements and movement information (e.g., step size and heading).

In some embodiments, the positioning application 1050 may receive and use the position estimates input from the positioning engine 1040. Usage of the position estimates may include, e.g., navigation, proximity detection, asset tracking, etc. These usages may include user interaction.

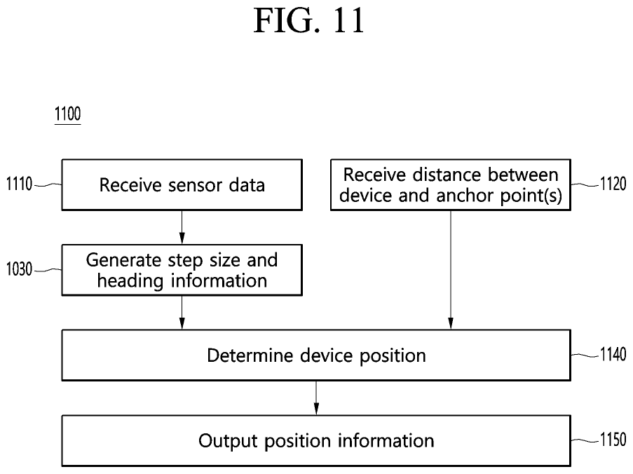

FIG. 11 shows an example of a high-level flow diagram depicting a process 1100 for position estimation, in accordance with some embodiments. In operation 1110, signals from one or more sensors may be received. For example, acceleration and orientation signals, e.g., from the IMU 1010, may be obtained. In operation 1120, ranging measurements indicative of the object's distance from one or more anchor points may be received, e.g., from the ranging device 1020. In operation 1130, step size and heading information may be generated, based on the signals obtained in operation 1110. In some embodiments, operation 1130 may be performed in the PDRU 1030. In operation 1140, a position may be determined, e.g., based on the ranging measurements and the step size and heading information above. In operation 1150, information of the position may be transmitted. For example, the position information may be transmitted to an application for further processing.

As shown in FIG. 11, in some embodiments, operations 1110 and 1130 may be performed independently, simultaneously or in parallel with operation 1120.

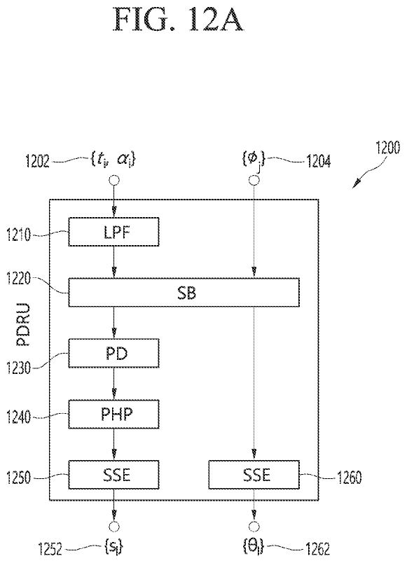

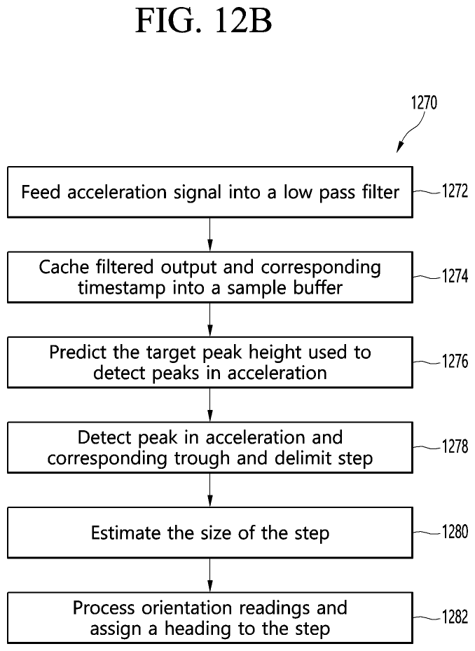

FIG. 12A shows an example high-level diagram of a PDRU 1200, in accordance with some embodiments. The PDRU 1200 may be similar to or the same as the PDRU 1030 of FIG. 10. In some embodiments, the PDRU 1200 may include, a low-pass filter (LPF) 1210, a sample buffer (SB) 1220, a peak detector (PD) 1230, a peak height predictor (PHP) 1240, a step-size estimator (SSE) 1250, and a step heading estimator (SHE) 1260.

FIG. 12B shows an example of a high-level flow diagram depicting a process 1270 for step size and heading estimation, in accordance with some embodiments. In some embodiments, the process 1270 may be performed in the PDRU 1200. In operation 1272, the process 1270 may feed an acceleration signal into a low pass filter (LPF), e.g., ith acceleration signal aᵢ at timestamp tᵢ{tᵢ, aᵢ} 1202 may be fed into the LPF 1210. The signal may be received from the IMU 1010. In some embodiments, the signal may be fed into the LPF sample by sample.

In some embodiments, the LPF 1210 may retain low frequency components of signals, e.g., as in acceleration signal received from the IMU 1010. In some embodiments, the filter may be a causal and linear-time invariant filter that follows an autoregressive moving average (ARMA) model according to the following equation:

$$\\ {a}_{n} = {\sum }_{k = 0}^{B - 1} {q}_{k} {x}_{n - k} - {\sum }_{l = 0}^{A - 1} {p}_{l} {a}_{n - l} ,$$

where {xₙ} is the raw acceleration input signal, {aₙ} is the filtered output signal, and {pₙ} and {qₙ} are referred to as the feed-forward and feed-back filter coefficients, and A and B are the degrees of the corresponding polynomials. In some embodiments, {pₙ} and {qₙ} may be the coefficients of a high-order Butterworth filter with a cutoff frequency in the range 0-5 Hz.

The acceleration signal {aₙ} may be the z-acceleration (the acceleration orthogonal to the screen of the device), the y-acceleration (the acceleration along the short edge of the device), a combination of the z-acceleration, y-acceleration, and x-acceleration (the acceleration along the long edge of the device), or the magnitude of the three-dimensional or two-dimensional acceleration vector.

In operation 1274, the filtered output from the LPF may be cached, e.g., in the SB 1220. In some embodiments, the cached information may be timestamped, i.e., the reading time reference. In some embodiments, the SB 1220 may temporarily store samples of the sensors (e.g., acceleration and orientation sensors) and their corresponding timestamps. In some embodiments, the SB 1220 may be implemented as a FIFO queue.

In operation 1276, the process 1270 may include predicting a target peak height, which may be used to detect peaks in acceleration. In operation 1278, steps may be delimited. In some embodiments, steps may be delimited based on the detected peaks and corresponding troughs. In some embodiments, operations 1276 and 1278 may be performed in the PD 1230 and PHP 1240. The operations 1276 and 1278 may be performed reiteratively.

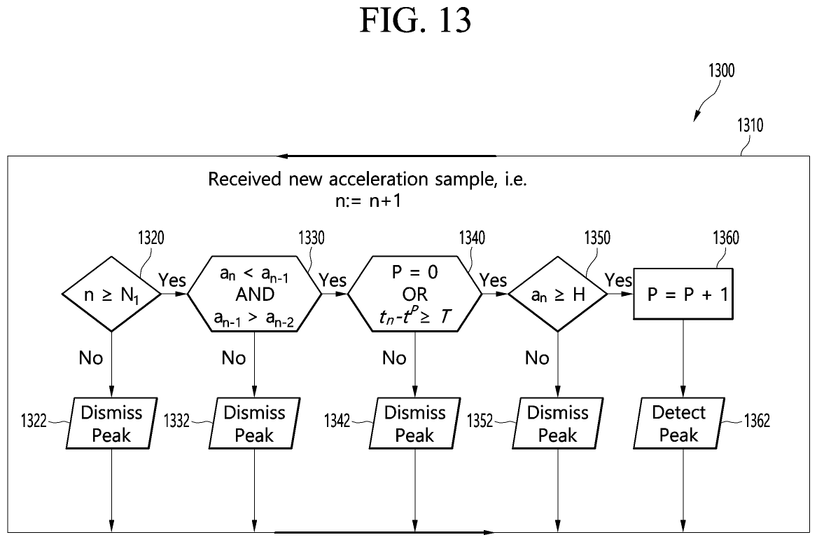

In some embodiments, the PD 1230 may detect peaks and troughs (valleys) in the acceleration signal for use to delimit steps in time. It has causal behavior. It should be noted that not all peaks result in steps, and not all steps turn into peaks. For example, the PD 1230 may take the output {aₖ} of the LPF 1210 and process it on a sample-by-sample basis (see also FIG. 13 below for further information).

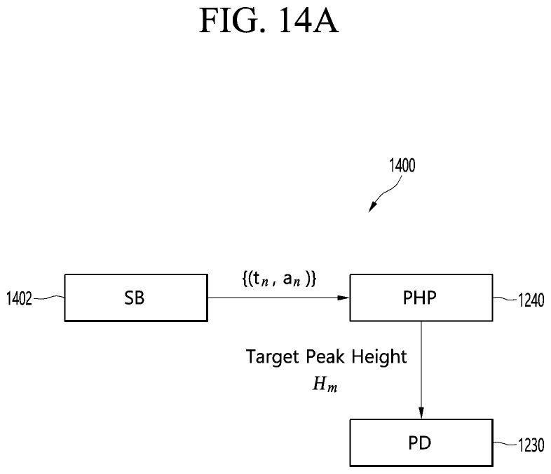

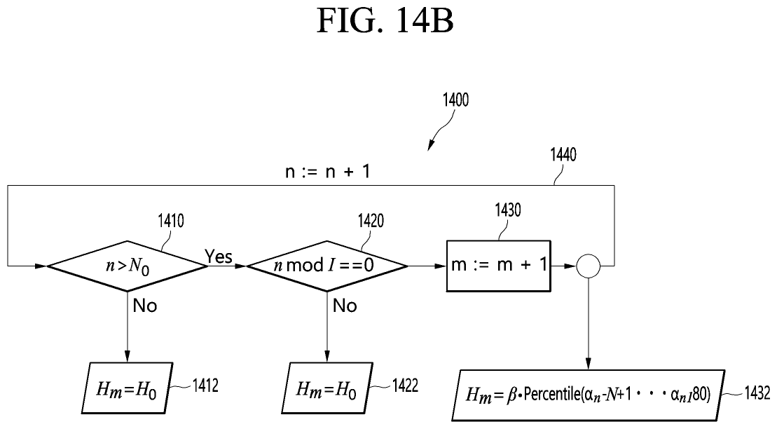

In some embodiments, the PHP 1240 may periodically predict the target peak height parameter used by the PD 1230 from the recent history of acceleration samples (see also FIG. 14 below for further information). The PHP 1240 may determine when a peak corresponds to a step.

In some embodiments, the PD 1230 may ignore a peak that has less than a target peak height H, a threshold for detecting a peak. The PD 1230 may also ignore a peak if the time since the last peak is less than a target inter-peak time T, a minimum required duration between consecutive peaks.

In operation 1280, a step size may be estimated, e.g., in the SSE 1250. In operation 1282, orientation readings may be obtained and processed. The information may then be used to assign a heading to the step.

FIG. 13 shows an example of a flow diagram depicting a process 1300 for processing filtered acceleration on a sample-by-sample basis, in accordance with some embodiments. In some embodiments, the process 1300 may be performed in the PD 1230. In some embodiments, an acceleration sample aₖ may result in a peak if 1) it comes T seconds after the last peak, 2) it has a value greater than H, and 3) it is a local maximum.

In operation 1310, the PD 1230 may receive an acceleration sample a with a sample index value n. In operation 1320, the PD may check if the sample index n reaches or exceeds a threshold, e.g., if n>=N₁, where N₁ is a predetermined threshold, e.g., N₁=3. If n>=N₁, the PD 1230 may move on to the next operation 1330; otherwise, the PD 1230 may dismiss the peak in operation 1322, increment the sample index n and return to operation 1310.

In operation 1330, the PD 1230 may check if the previous acceleration sample aₙ₋₁ is a local maximum, i.e., if aₙ<aₙ₋₁ and aₙ₋₁>aₙ₋₂. If true, the PD 1230 may move on to the next operation 1340; otherwise, the PD 1230 may dismiss the peak in operation 1332, increment the sample index n and return to operation 1310.

In operation 1340, the PD 1230 may check if any of the following conditions are true: the peak count P=0, or the time since the last peak (tₙ−t^{P}) is greater than or equal to the target inter-peak time T. In some embodiments, T may be a number in the range of 100-1000 ms, inclusively. If the check is true, the PD 1230 may move on to the next operation 1350; otherwise, the PD 1230 may dismiss the peak in operation 1342, increment the sample index n and return to operation 1310.

In operation 1340, the PD 1230 may check if the acceleration sample aₙ is greater than or equal to the target peak height H. If true, in operation 1360, the PD 1230 may increment the peak count and declare, in operation 1362, that a peak has been detected, increment the sample index n and return to operation 1310; otherwise, the PD 1230 may dismiss the peak in operation 1352, increment the sample index n and return to operation 1310.

FIGS. 14A and 14B show an example of a flow diagram depicting a process 1400 for predicting the target peak height, in accordance with some embodiments. In some embodiments, the process 1400 may be performed in the PHP 1240. The PHP 1240 may periodically predict the target peak height from the recent history of acceleration samples. The predicted target peak height may be fed back to, and used by, the PD 1230 as shown in FIGS. 12A-B and 13.

In some embodiments, as shown in FIG. 14A, the PHP 1240 may receive the last number (W) of acceleration samples (acceleration aₙ at time tₙ) from a sample buffer 1402 (e.g., SB 1220), compute the target peak height Hₘ, and feed it into the PD 1230.

As shown in FIG. 14B, in some embodiments, the PHP 1240 may periodically predict the target peak height parameter used by the PD 1230 from the recent history of acceleration samples. FIG. 14B shows an example sample-by-sample implementation. The variable n is the acceleration sample index. The variable m is the PHP update cycle counter.

For example, in operation 1410, if the number of acceleration samples (n) in the SB is determined to be less than or equal to a threshold (N₀), n=<N₀, the PHP 1240, in operation 1412, may use a default peak target height of H₀(setting Hₘ=H₀); otherwise, the PHP 1240 may proceed to the next operation 1420.

In operation 1420, if the number of samples n is determined not a multiple of the peak update interval I≥N₀, which determines the epochs at which the peak height is updated, or, alternatively, if n mod I>0, the PHP 1240, in operation 1422, may use a default peak target height of H₀(setting Hₘ=H₀); otherwise, the PHP 1240 may proceed to the next operation 1430.

In operation 1430, the PHP 1240 may update the variable m cycle counter; and, in operation 1432, the PHP 1240 may update the target peak height as a function of the R^{th} percentile amplitude of the most recent N₁ acceleration samples {a_{n-N1+1}, . . . , aₙ}, e.g., according to the following equation:

$$\\ {H}_{m} = β \cdot PERCENTILE ( \{ {a}_{n - {N}_{1} + 1} , … , {a}_{n} \} , R ) ,$$

where 0<β≤1 is a tuning parameter, which may be obtained through testing across different users and walking speeds. In some implementations, R may be defined through a grid search on a large dataset.

In operation 1140, the PHP 1240 may loop back to operation 1410. In some embodiments, the PD 1230 may use a default target peak height. Once there are enough peaks, the PHP 1240 may adapt to the walking intensity of the user, and estimate a new target peak height. The PHP 1240 may then feedback this new target peak height to the PD 1230.

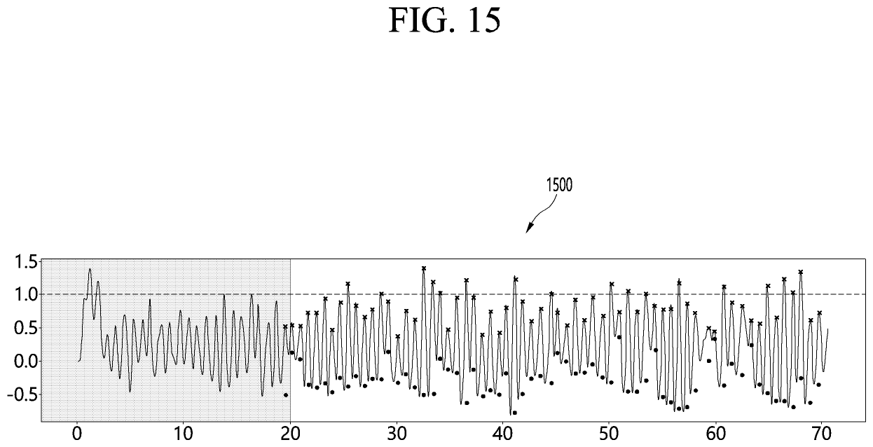

FIG. 15 shows a graph 1500 depicting an example of the process of predicting peak height. For example, during the first I=20 seconds (horizontal x axis), an aggressive target peak height of 1 m/s² may be chosen (vertical y axis), so all peaks that are below the target may not be detected. In some embodiments, only peaks that are significantly below the target may not be detected. After that, the target peak height may be adjusted to walking intensity, and every single peak may be detected.

In some embodiments, the SSE 1250 may estimate the size of the steps detected by the PD 1230. The SSE 1250 may use alternative ways to compute the size of the step from the acceleration signal.

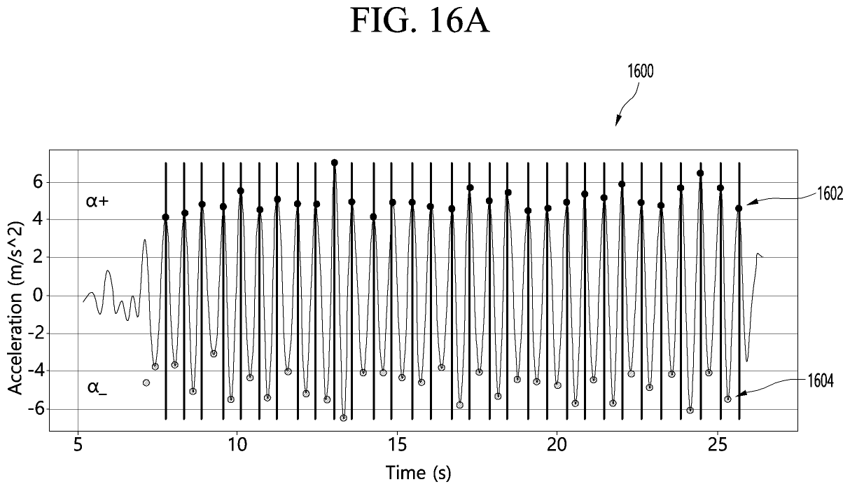

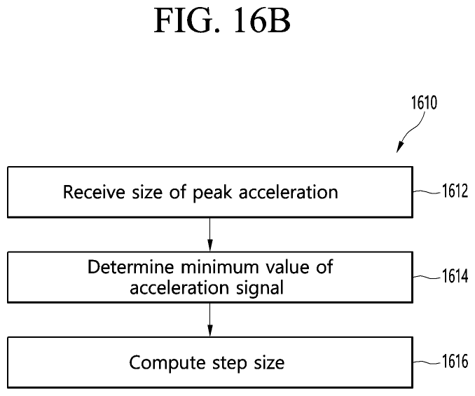

FIG. 16A shows a graph 1600 depicting an example of the process of estimating a step size. In some embodiments, the SSE 1250 may compute the size of detected steps (delimited by vertical y axis) as a function of the corresponding peak 1602 and trough 1604.

FIG. 16B shows an example of a high-level flow diagram depicting a process 1610 for computing step size (see {sₗ}1252 in FIG. 12A), in accordance with some embodiments. In some embodiments, the process 1610 may be performed in the SSE 1250. In some embodiments, when a peak/step is detected, the SSE 1250 may perform the process 1610. In operation 1612, the SSE 1250 may receive the size of a peak a₊ from the PD 1230. In operation 1614, the SSE 1250 may determine the minimum value a₋ of the acceleration signal between the two most recent peaks. This may be done, for example, by indexing the AB 1402 and performing a search. In another example, a running minimum a₋ may be tracked as follows:
a. Start with a₋=∞.
b. Update a₋ on a sample-by-sample basis with every new acceleration sample aₙ.
c. Reset a₋ to ∞ once a peak is detected, but only after its value is used according to the next step.

In operation 1616, the SSE1250 may compute the step size. In some embodiments, the SSE1250 may compute the step size according to the commonly known Weinberg equation, as follows:

$$s = α \cdot \sqrt[4]{{a}_{+} - {a}_{-} ,} ,$$

where α is the Weinberg coefficient, and its value may be found through an offline search over a range of values.

The SSE 1250 may also use other methods to compute the size of the step from the acceleration signal. For example, the SSE 1250 may use an artificial intelligence (AI) regression model that may take the sequence of acceleration along the duration of the step, or engineered feature thereof, and that has been trained offline. In another example, the SSE 1250 may use other closed form models, e.g., the commonly known Kim model, which expresses the step size as follows:

$$s = K \cdot \sqrt[3]{\frac{\sum \vert {a}_{n} \vert}{N}}$$

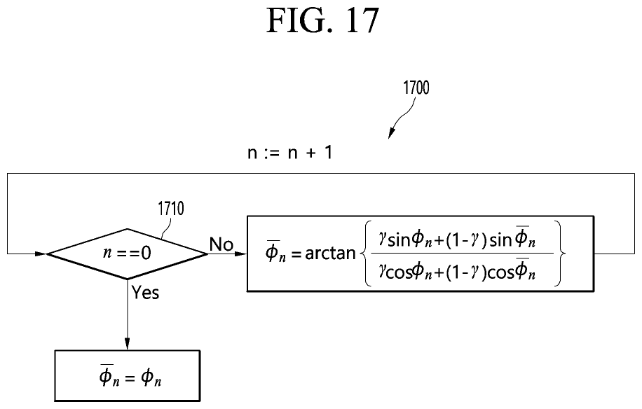

FIG. 17 shows an example of a flow diagram depicting a process 1700 for estimating the step heading, in accordance with some embodiments. In some embodiments, the process 1700 may be performed in the SHE 1260.

In some embodiments, the PDRU, e.g., the SHE 1260 in PDRU 1200, may use the exponential moving circular average (EMCA) to compute the heading of a detected step from orientation readings {ϕₙ}. For example, these readings may be readings {ϕⱼ} 1204 as shown in FIG. 12A. The orientation readings may be derived from the readings of the magnetometer, gyroscope, and other sensors. An EMCA gives more weight to more recent readings of orientation than an ordinary, or simple moving circular average (SMCA). Using AMCA may make the SHE more responsive to sharp turns in motion. In some embodiments, upon detecting a step l, the SHE 1260 may perform the process 1700.

In operation 1710, if it is determined that n=0, the SHE 1260 may initialize the EMCA filter by setting the average orientation ϕ̅ to ϕₙ (i.e., ϕ̅ₙ=ϕₙ). In other words, when n=0, this is the very first orientation sample, and there is no averaging to be performed, so this sample may be used in place of an average, Otherwise, the SHE 1260 may filter ϕₙ using the EMCA according to the equation in operation 1720:

$${\overline{ϕ}}_{n} = arctan ( \frac{γ \cdot sin {ϕ}_{n} + ( 1 - γ ) \cdot sin {\overline{ϕ}}_{n}}{γ \cdot cos {ϕ}_{n} + ( 1 - γ ) \cdot cos {\overline{ϕ}}_{n}} ) ,$$

where 0<γ<1. Alternatively, γ may be computed according to the following equation:

$${γ}_{n} = 1 - {e}^{- δ \cdot \vert {ϕ}_{n} - {\overline{ϕ}}_{n} \vert} ,$$

where δ>0 may control the reaction speed to a sharp turn.

The SHE 1260 may take a snapshot of the averaged orientation ϕ̅ and sets the heading θₗ (see {θₗ}1262 in FIG. 12A) of the detected step to ϕ̅.

As a result, the PDRU 1200 may match every peak l to a corresponding step l described by a size and a heading (sₗ θₗ), where sₗ is size and θₗ is heading. In some embodiments, the PDRU 1200 may stream the detected steps, specifically their sizes and headings, to the positioning operation (e.g., positioning engine 1040) where they can be used to predict the movement of the user holding the device and track its trajectory.

As used herein, a reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

As used herein, the term “couple” and its derivatives refer to any direct or indirect communication between two or more elements, whether or not those elements are in physical contact with one another. The terms “transmit,” “receive,” and “communicate,” as well as derivatives thereof, may encompass both direct and indirect communication. The terms “include” and “comprise,” as well as derivatives thereof, mean inclusion without limitation. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely.

Various functions described herein may be implemented or supported by one or more computer programs, each of which may be formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” may include any type of computer code, including source code, object code, and executable code. The phrase “computer readable medium” may include any type of medium capable of being accessed by a computer, such as read only memory (ROM), random access memory (RAM), a hard disk drive, a compact disc (CD), a digital video disc (DVD), or any other type of memory. A non-transitory computer readable medium may include media where data can be permanently stored and media where data can be stored and later overwritten, such as a rewritable optical disc or an erasable memory device.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A method for estimating a position of an object, the method comprising:
receiving an acceleration signal and an orientation signal;
receiving one or more ranging measurements;
generating step size information based on the acceleration signal;
generating step heading information based on the orientation signal; and
estimating the position of the object based on the one or more ranging measurements, the step size information and the heading information.

2. The method of claim 1, wherein the one or more ranging measurements include distance information between the object and one or more anchor points.

3. The method of claim 1, wherein the generating the step size information comprises:
detecting a plurality of peaks in the acceleration signal based on a target peak height and a target inter-peak time.

4. The method of claim 3, wherein the generating the step size information comprises:
predicting the target peak height based on a number of acceleration samples in the acceleration signal.

5. The method of claim 4, wherein the generating the step size information comprises:
estimating step size based on the detected plurality of peaks.

6. The method of claim 1, wherein the step heading information is determined based on orientation information in the orientation signal using a moving average method that attributes greater weight to a predetermined number of recent orientation information.

7. The method of claim 3, wherein each detected peak has a peak that is greater than or equal to the target peak height and a duration between the peak and an immediately preceding peak is greater than or equal to the target inter-peak time.

8. The method of claim 4, wherein the predicting the target peak height comprises:
setting the target peak height to a default value when the number of acceleration samples is less than a first threshold; and
setting the target peak height using a function of a percentile amplitude of a number of recent acceleration samples when the number of acceleration samples is larger than the first threshold and a multiple of a predetermined value.

9. The method of claim 1 further comprising:
obtaining the acceleration signal and the orientation signal; and
filtering the acceleration signal and the orientation using a low-pass filter.

10. The method of claim 2, wherein the distance is determined using one of time of flight, round-trip time, downlink time difference of arrival, uplink time difference of arrival, received signal strength indicator, or channel state information.

11. A device for estimating a position of an object associated with a user, comprising:
a memory; and
a circuitry connected to the memory, the circuitry configured to:
receive an acceleration signal and an orientation signal;
receive one or more ranging measurements;
generate step size information based on the acceleration;
generate step heading information based on the orientation signal; and
estimate the position of the object based on the one or more ranging measurements, the step size information and the heading information.

12. The device of claim 11, wherein the one or more ranging measurements include a distance between the object and one or more anchor points.

13. The device of claim 11, wherein to generate the step size information, the circuitry is configured to:
detect a plurality of peaks in the acceleration signal based on a target peak height and a target inter-peak time.

14. The device of claim 13, wherein to generate the step size information, the circuitry is configured to:
predict the target peak height based on a number of acceleration samples in the acceleration signal.

15. The device of claim 14, wherein to generate the step size information, the circuitry is configured to:
estimate step size based on the detected plurality of peaks.

16. The device of claim 11, wherein the step heading information is determined based on orientation information in the orientation signal using a moving average method that attributes greater weight to a predetermined number of orientation information.

17. The device of claim 13, wherein each detected peak has a peak that is greater than or equal to the target peak height and a duration between the peak and an immediately preceding peak is greater than or equal to the target inter-peak time.

18. The device of claim 14, wherein to predict the target peak height, the circuitry is configured to:
set the target peak height to a default value when the number of acceleration samples is less than a first threshold; and
set the target peak height using a function of a percentile amplitude of a number of recent acceleration samples when the number of acceleration samples is larger than the first threshold and a multiple of a predetermined value.

19. The device of claim 11, wherein the circuitry is further configured to:
obtain the acceleration signal and the orientation signal; and
filter the acceleration signal and the orientation using a low-pass filter.

20. The device of claim 12, wherein the distance is determined using one of time of flight, round-trip time, downlink time difference of arrival, uplink time difference of arrival, received signal strength indicator, or channel state information.
